(19) United States
(12) Patent Application Publication
(10) Pub. No.: US 2006/0143151 A1
(43) Pub. Date: Jun. 29, 2006

(54) Methods, systems and computer programs for facilitating access to an electronic datum

(75) Inventors: Anand Prahlad, Bangalore (IN); Shailesh Pravinchandra Gandhi, Bangalore (IN); Balasubramaniyan Krithivasan, Bangalore (IN); Sunil Chandurkar, Begumpeth (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/297,440

(22) Filed: Dec. 9, 2005

(30) Foreign Application Priority Data
Dec. 10, 2004 (GB) 0427048.4

(51) Int. Cl. G06F 17/30

(52) U.S. Cl. 707/1

(57) ABSTRACT

In an embodiment of a method of facilitating access to an electronic datum, the embodiment includes the step of providing a computer system with first data that identifies the electronic datum. The embodiment also includes the step of receiving from the computer system second data that identifies a file system that is associated with the electronic datum. In addition to the previous two steps the embodiment includes the step of providing the second data to a file system mounting process to effect mounting of the file system and thereby facilitating access to the electronic datum.

### FIELD OF THE INVENTION

The present invention relates generally to methods, systems and computer programs for facilitating access to an electronic datum, and has particular—but by no means exclusive—application to mounting a file system to allow the electronic datum to be accessed.

### BACKGROUND OF THE INVENTION

Computer systems generally employ a file system to organise and keep track of electronic data on a storage device such as a hard disk or CD-ROM. Essentially, a file system is a set of abstract data types that are used to store, hierarchically organise, manipulate, navigate, access and retrieve the electronic data on the storage device. Some of the more popular file systems used today include: EXT2, which is used by the Linux operating system; FAT, which is used in the DOS operating system; ISO 9660, which is used for writing data to a CD-ROM; and NFS, which is used for accessing data via a network.

The process of making a file system available for use is commonly described as ‘mounting’ the file system. In a UNIX based operating system a file system on a local storage device can be mounted by invoking the mount command. For example, a person could mount a CD-ROM based file system by invoking the mount command as follows: mount -r-t iso9660/dev/cdrom /mnt. Invoking the mount command as previously specified would effectively cause the file system on a CD-ROM, which is located at /dev/cdrom, to be accessible under the /mnt directory.

Existing techniques for mounting file systems (on local and remote storage devices) can be considered an active process in that they generally require a person to provide one or more parameters, which typically include the type and location of the file system to be mounted. In the previous mount command example, the parameters provided by the person include iso9660 (which identifies the file system type) and /dev/cdrom (which identifies the location of the file system).

To make effective use of existing techniques for mounting file systems the person should have a reasonable technical knowledge of computers. Consequently, laypersons may find it difficult, if not impossible, to mount a file system using existing techniques.

### SUMMARY OF THE INVENTION

In an embodiment of a method of facilitating access to an electronic datum, the embodiment includes the step of providing a computer system with first data that identifies the electronic datum. The embodiment also includes the step of receiving from the computer system second data that identifies a file system that is associated with the electronic datum. In addition to the previous two steps the embodiment includes the step of providing the second data to a file system mounting process to effect mounting of the file system to thereby facilitate access to the electronic datum.

The present invention will be more fully understood from the following description of a specific embodiment. The description is provided with reference to the accompanying figs.

### BRIEF DESCRIPTION OF THE DRAWINGS

FIG. 1 is schematic diagram of a system in accordance with an embodiment of the present invention;

FIG. 2 is a flow chart of the steps involved in a process that is performed by the system of FIG. 1 to effect mounting of a file system; and

FIG. 3 is a flow chart of the steps involved in another process that is performed by the system of FIG. 1 to effect mounting of a file system.

### DETAILED DESCRIPTION

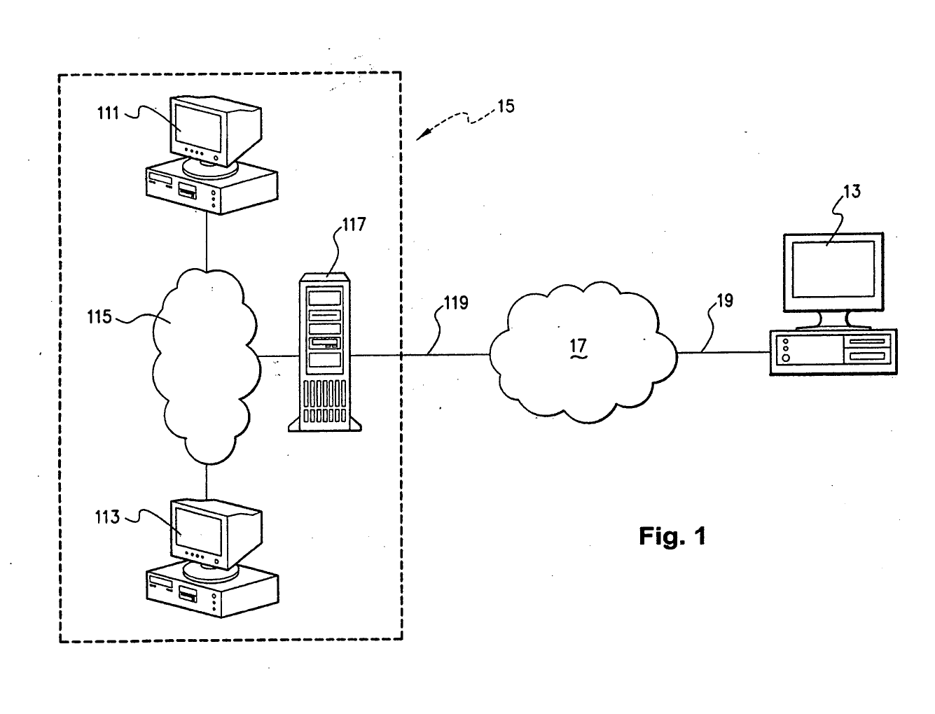

With reference to FIG. 1, a system 11 embodying the present invention includes a personal computer 13, a computer system 15, and a communication network 17.

The personal computer 13 enables a person to access at least one electronic datum that is maintained using a file system that is exported from the computer system 15. The electronic datum can include, for example, an MPEG file, a word processor file or a spreadsheet file. To enable the person to access the electronic datum the personal computer 13 is made up of numerous components that cooperate with each other. The components include: a power supply; motherboard; random access memory; a video card; a monitor; a network interface; and a hard disk loaded with the Linux operating system and a file system mounting program. Essentially, the file system mounting program is responsible for mounting onto the personal computer 13 the file system that is exported from the computer system 15. The file system mounting program relies on the other components of the personal computer 13 (for example, the motherboard and the Linux operating system) to provide an environment in which the file system mounting program can be executed.

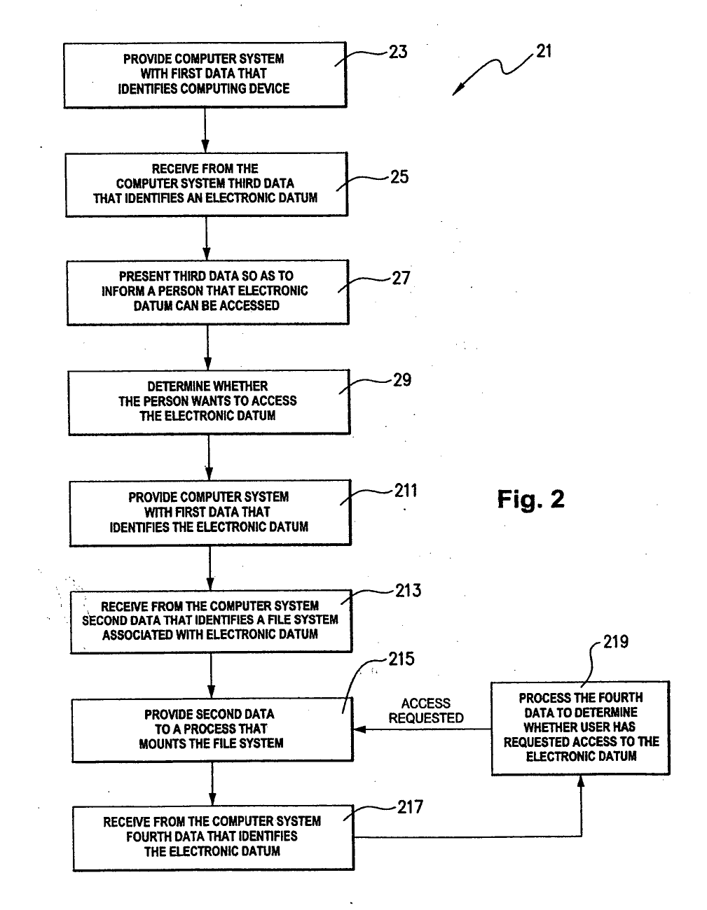

The various steps that the file system mounting program performs when mounting the file system are shown in the flowchart 21 of FIG. 2. The first step 23 that the file system mounting program performs is to provide the computer system 15 with data that identifies the personal computer 13. The first step 23 is carried out shortly after the file system mounting program commences execution. To carry out the first step 23 the file system mounting program interacts with the network interface of the personal computer 13 to supply the data to the communication network 17, which in turn transfers the data to the computer system 15. To supply the communication network 17 with the data, the network interface of the personal computer 13 is connected to a communication link 19 that is connected to the communication network 17. In the present embodiment of the system 11 the communication link 19 is in the form of an XDSL link.

The second step 25 that the file system mounting program performs is to receive from the computer system 15 data that identifies the electronic datum that is maintained in the file system that is exported from the computer system 15. The data received during the second step 25 effectively identifies any data that are maintained in the file system that is exported from the computer system 15. To receive the data during the second step 25 the file system mounting program interacts with the network interface of the personal computer 13, which receives the data from the communication network 17 via the communication link 19. In the present embodiment of the invention the data received during the second step 25 is a description of the content of the electronic datum. More specifically, the data received during the second step 25 could be anything that a person wishes to assign to the electronic datum. For example, if there were thirty electronic datum (files) all of which are MP3 music files then the data received during the second step 25 could be used to describe the categories of the thirty electronic datum. For instance, if there were three categories related to music then the data received during the second step 25 might be “Music from the 1960s”, “Music from the 1970s”, and “Contemporary music”.

Subsequent to performing the second step 25, the file system mounting program proceeds to carry out the third step 27 of causing the data, which was received during the second step 25, to be presented in a graphical user interface on the monitor of the personal computer 13. The purpose of presenting the data in the graphical user interface is to inform the person using the personal computer 13 that the electronic datum is available for accessing. To cause the data to be presented in the graphical user interface the file system mounting program interacts with the Linux operating system running on the personal computer 13, which is responsible for managing the graphical user interface. In the previous example of three categories of music, presenting the data in the graphical user interface would cause the text strings “Music from the 1960s”, “Music from the 1970s”, and “Contemporary music” to be presented in the graphical user interface.

The graphical user interface used to present the data during the third step 27 is such that the person using the personal computer 13 can indicate their desire to access the electronic datum that is maintained by the file system that is exported by the computer system 15 by ‘clicking’ on (or selecting) a representation of the data in the graphical user interface. In the previous music category example, clicking on the representation would involving clicking on the text string “Music from the 1960s”, which is displayed as the representation in the graphical user interface. The ability to allow the person to indicate their desire to access the electronic datum allows the file system mounting program to perform the fourth step 29 of determining whether the person using the personal computer 13 wants to access the electronic datum that is maintained by the file system, which is exported from the computer system 15. To perform the fourth step 29 the file system mounting program interacts with the Linux operating system to determine whether the person has clicked on the representation of the data in the graphical user interface.

If as a result of performing the fourth step 29 it is determined that the person using the personal computer 13 wants to access the electronic datum, the file system mounting program proceeds to carry out the fifth step 211 of providing the computer system 15 with data that identifies the electronic datum selected by the user. The data sent to the computer system 15 during the fifth step 211 effectively notifies the computer system 15 that the personal computer 13 requires access to the electronic datum. To provide the computer system 15 with the data the file system mounting program uses the network interface of the personal computer 13 to supply the data to the communication network 17 via the communication link 19. The communication network 19 is arranged to transfer the data to the computer system 15.

Following on from the fifth step 211, the file system mounting program proceeds to carry out the sixth step 213 of receiving from the computer system 15 data that identifies the file system that is exported from the computer system 15 and which is used to maintain the electronic datum. To receive the data from the computer system 15 during the fifth step 211, the file system mounting program interacts with the network interface of the personal computer 13, which receives the data from the communication network 17 via the communication link 19. The data that the file system mounting program receives during the sixth step 213 are effectively parameters that are required to mount the file system. In the present embodiment of the invention the data received during the sixth step 213 represents a text string of the form host-name:remote-pathname; where host-name is the domain name assigned to the computer system 15, and remote-pathname is the pathname of the file system that is associated with the electronic datum.

Once the file system mounting program has carried out the sixth step 213, the file system mounting program proceeds to carry out the seventh step 215 of providing the data that was received during the sixth step 213 to a process that is arranged to mount file systems. Using the data that is passed to it, the process for mounting file systems effectively mounts on the personal computer 13 the file system that is exported from the computer system 15 and which is associated with the electronic datum. To achieve this the process that is arranged to mount file systems operates in accordance with the semantics of the mount command.

It is noted that the seventh step 215 is performed independently of the person using the personal computer 13; that is, the person is not required to supply any of the parameters that are provided to the process for mounting file system, such as host-name or remote-pathname. An advantage of performing the seventh step 215 independently of the person is that the user does not need to have a reasonable technical knowledge of computers, which is generally the case for existing techniques for mounting file systems. It can be difficult for laypersons to mount a file system they have no knowledge about or a file system that has not been exported. The embodiment of the present invention, however, enables laypersons to easily mount a file system provided the electronic datum has been categorised and exported by the computer system 15.

As described in subsequent paragraphs of this specification, one of the functions performed by the computer system 15 is to advise the personal computer 13 that the electronic datum, which is accessible via the file system exported from the computer system 15, has been updated. In this regard, the file system mounting program of the personal computer 13 carries out the eighth step 217 of receiving from the computer system data that identifies the electronic datum. The data received during the eighth step 217 is effectively a notification that the electronic datum has been updated. To obtain the data during the eighth step 217 the file system mounting process interacts with the network interface of the personal computer 13, which receives the data from the communication network 17 via the communication link 19.

Following on from the eighth step 217, the file system mounting program carries out the ninth step 219 of processing the data received during the eighth step 217 to determine whether the person using the personal computer 13 has previously requested access to the electronic datum; that is, the seventh step 215 of mounting the file system has been performed to provided the person with access to the electronic datum. More specifically, the ninth step 219 involves checking an electronic record containing details of electronic data that the person previously requested access to. This record is updated whenever the personal computer provides access (mounts a file system) to electronic data that is maintained by a file system exported from the computer system 15. If as a result of performing the ninth step 219 it is determined that the person has previously requested access to the electronic datum, the file system mounting program re-executes the seventh step 215 to effect re-mounting of the file system exported from the computer system 15. If on the other hand it is determined that the user did not previously request access to the electronic datum, the file system mounting process takes no action.

As described in the preceding paragraphs of this specification, the computer system 15 performs various functions that enable the personal computer 13 to make the electronic datum accessible to the person using the personal computer 13. The various functions performed by the computer system 15 relate generally to providing the personal computer 13 with the parameters (data) necessary for mounting the file system that is exported by the computer system 15. To perform the various functions the computer system 15 includes a repository computer 111, at least one publisher computer 113, a computer network 115 and a data switch 117. The repository computer 111, the publisher computer 113, and the data switch 117 are connected to the network 115. The data switch 117 is also connected to the communication network 17 via a communication link 119, which supports the XDSL standard.

The primary function of the data switch 117 is to transfer data between the communication network 17 and the computer network 115. To carry out this function the data switch 117 includes: a motherboard; random access memory; a network interface that is connected to the computer network 115 and the communication link 119; and a storage device that is loaded with an operating system and a program that is responsible for switching data between the computer network 115 and the communication link 119.

The computer network 115 is a TCP/IP based intranet and is therefore made up of infrastructure including interconnected hubs and routers that support the TCP/IP protocol suite.

The repository computer 111 and the publisher computer 113 each include the following components: a power supply; a motherboard; random access memory; a network interface that is connected to the computer network 115; and a hard disk loaded with the Linux operating system and a file system mounting application. Essentially, the file system mounting applications on the repository computer 111 and the publisher computer 113 cooperate with each other to allow the computer system 15 to perform the various functions that enable the personal computer 13 to make the electronic datum accessible to the person using the computer 13. The file system mounting applications also rely on the other components of the repository computer 111 and the publisher computer 113 to provide an environment in which the file system mounting applications can be executed.

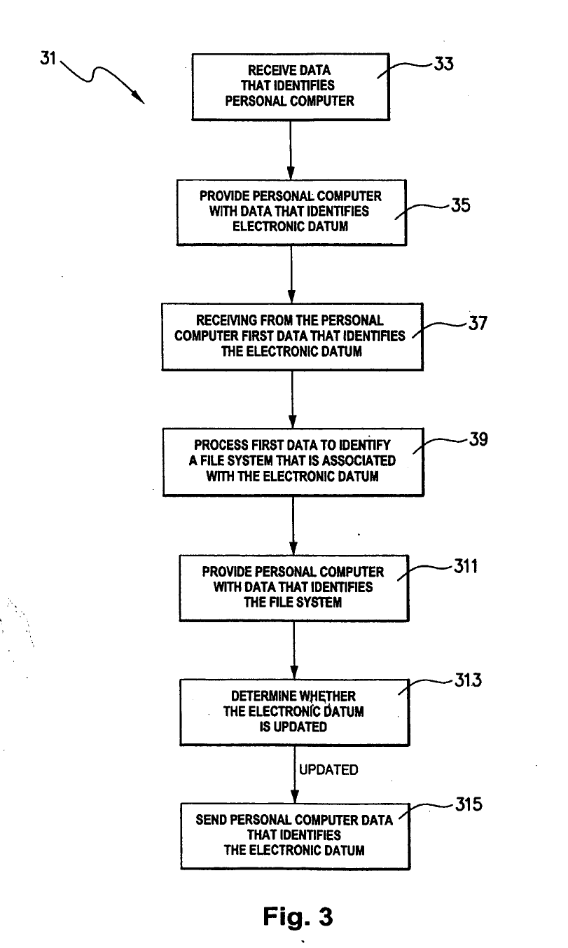

The various steps that the file system mounting applications perform are shown in the flow chart 31 of FIG. 3. In this regard, the first step 33 that is performed is to receive data that identifies the personal computer 13. The repository computer 111 performs the first step 33. The data received during the first step 33 is actually the data that the personal computer 13 provides when it carries out its first step 23. To enable the repository computer 111 to carry out the first step 33, the data switch 117 broadcasts the data, which the switch 117 receives via the communication link 119, on the computer network 115. To carry out the first step 33 of receiving the data the file system mounting application on the repository computer 111 obtains the data from the network interface of the repository computer 111, which in turn received the data via the computer network 115. The publisher computer 113 ignores any data that the data switch 117 broadcasts on the computer network 115 in relation to the first step 33.

On completing the first step 33, the file system mounting application on the repository computer 111 proceeds to carry out the second step 35 of providing the personal computer 13 with data that identifies the electronic datum that is maintained by the file system which the computer system 15 exports. The data that is provided to the personal computer 13 during the second step 35 is the data that the personal computer 13 receives when it performs its second step 25. As indicated previously, this data typically represents a text string describing the contents of the electronic datum. For example, if the electronic datum is a music track from the 1960s the data provided during the second step 35 could be “Music from the 1960s”. To effect the second step 35, the file system mounting application of the repository computer 111 supplies the data to the network interface of the repository computer 111. The network interface in turn places the data onto the computer network 115, which transfers the data to the data switch 117. On receiving the data the data switch 117 transfers the data to the communication network 17 via the communication link 119. The communication network subsequently delivers the data to the personal computer 13.

To enable the file system mounting application on the repository computer 111 to perform the second step 35, the publisher computer 113 provides the repository computer with the data that identifies the electronic datum that is maintained by the file system which the computer system 15 exports. As described in the following paragraphs of this specification the repository computer 111 only acts as a repository for information pertaining to the electronic datum, which is actually exported by the publisher computer 113; that is, the publisher computer 113 is actually responsible for the file system exported from the computer system 15. In order to export the file system the publisher computer 113 exports the file system in accordance with the semantics of the mount command. The repository computer 111 generally does not export any file system. Whenever the publisher computer 113 wishes to export (share) a new electronic datum the publisher computer 113 sends to the repository computer 111 the data which identifies the new electronic datum. In this regard, the publisher computer 113 uses its network interface to send the data to the repository computer 111 via the computer network 115. The repository computer 111 uses its network interface to receive the data via the computer network 115.

Following on from the second step 35, the third step 37 is performed by the file system mounting application loaded on the publisher computer 113. The third step 37 involves receiving from the personal computer 13 data that identifies the electronic datum. The data received during the third step 37 is the data that the personal computer 13 provides when it carries out its fifth step 211. The data received during the third step 37 effectively indicates that the person using the personal computer 13 wishes to access the electronic datum that is maintained by the file system that is exported from the computer system 15. To carry out the third step 37 the file system mounting application on the publisher computer 113 obtains the data from the network interface of the publisher computer 113, which receives the data from the computer network 115. The data is placed onto the computer network 115 by the data switch 117, which receives the data from the communication network 17 via the communication link 119.

The fourth step 39 performed by the file system mounting program on the publisher computer 113 involves processing the data received during the third step 37. More specifically, the fourth step 39 involves processing the data to identify the file system that the publisher computer 113 uses to manage the electronic datum. In the present embodiment of the invention identifying the file system includes determining the directory in which the electronic datum is located. For example, the directory might be /usr/local/music if the electronic datum is an MP3 music file. The file system mounting program of the publisher computer 113 determines the directory information by using the disk I/O functions of the Linux operating system.

On identifying the file system, the file system mounting application on the publisher computer 113 proceeds to carry out the fifth step 311 of providing the personal computer 13 with data that identifies the file system that was identified during the previous step 39. The data provided to the personal computer 13 during the fifth step 311 is the data that the personal computer receives during the sixth step 213. As such, the data that the publisher computer 113 sends to the personal computer 13 during the fifth step 311 represents a string of the following form: host-name:remote-pathname, where host-name is the domain name of the publisher computer 113 and remote-pathname is the directory containing the electronic datum. To effect the fifth step 311 the file mounting application on the publisher computer 113 provides the data to the network interface of the publisher computer 113, which in turn sends the data to the data switch 117 via the computer network 115. On receiving the data the data switch 117 sends the data to the personal computer 13 via the communication link 119 and the communication network 17.

The file system mounting application on the publisher computer 113 is also arranged to carry out the sixth step 313 of determining whether the electronic datum is updated. For example, in the event that the electronic datum is a word processor document the sixth step 313 would involve determining whether the text of the document has undergone a change. When performing the sixth step 313 the file system mounting application on the publisher computer 113 monitors for a write access being made to the electronic datum.

In the event that the file system mounting application on the publisher computer 113 detects a write access being made to the electronic datum (that is, the electronic datum is updated), the file system mounting application carries out the seventh step 315 of providing the personal computer 13 with data that identifies the electronic datum. The seventh step 315 effectively notifies the personal computer 13 that the electronic datum has been updated. The data provided to the personal computer 13 during the seventh step 315 is the data that the personal computer 13 receives when carrying out the eighth step 217. To effect the seventh step 315, the file system mounting application on the publisher computer 113 supplies the data to the network interface of the publisher computer 113. On receiving this data the network interface sends the data to the data switch 117 via the computer network 115. The data switch 117 sends this data to the personal computer 13 via the communication link 119 and the communication network 17.

As described in the previous paragraphs, the personal computer 13 and the computer system 15 use the communication network 17 to exchange data between each other. The data that the personal computer 13 and the computer system 15 exchange between each other is in the form of Internet Protocol (IP) packets. Therefore, the communication network 17 includes interconnected routers that support the IP protocol.

It will be readily appreciated by those skilled in the art that whilst the present embodiment of the invention has been described in the context of the Linux operating system, the invention has application to a range of operating systems such as Microsoft XP and HP-UX.

Persons skilled in the art will also readily appreciate that even though the description of the present embodiment describes the communication links 19 and 119 in the context of xDSL, the invention is independent of the type of data communication standards used on the links 19 and 119. Consequently, the communication links 19 and 119 could support a range of standards including ISDN and various LAN standards.

What is claimed is:

1. A method of facilitating access to an electronic datum, the method comprising the steps of:
providing a computer system with first data that identifies the electronic datum;
receiving from the computer system second data that identifies a file system that is associated with the electronic datum; and
providing the second data to a file system mounting process to effect mounting of the file system and thereby facilitate access to the electronic datum.

2. The method as claimed in claim 1, wherein the step of providing the second data is performed independently of a person.

3. The method as claimed in claim 1, further comprising the steps of:
receiving from the computer system third data that identifies the electronic datum;
presenting the third data so as to inform a person that the electronic datum can be accessed;
determining whether the person wants to access the electronic datum; and
performing the step of providing the computer system with the first data upon determining that the person wants to access the electronic datum.

4. The method as claimed in claim 3, further comprising the steps of:
receiving from the computer system fourth data that identifies the electronic datum;
processing the fourth data to determine whether a person has requested access to the electronic datum; and
performing the step of providing the second data to the file system mounting process upon determining that the person has requested access to the electronic datum.

5. The method as claimed in claim 4, further comprising the step of providing the computer system with fifth data that identifies a computing device on which the file mounting process can mount the file system.

6. The method as claimed in claim 5, wherein the step of providing the computer system with the first data comprises the step of sending the first data to the computer system via a communication network, and wherein the step of providing the fifth data to the computer system comprises the step of sending the fifth data to the computer system via the communication network.

7. The method as claimed in claim 5, wherein the step of receiving from the computer system the second data comprises the step of receiving the second data via a communication network, and wherein the step of receiving from the computer system the third data comprises the step of receiving the third data via the communication network, and wherein the step of receiving from the computer system the fourth data comprises the step of receiving the fourth data via the communication network.

8. A method of facilitating access to an electronic datum, the method comprising the steps of:
receiving from a computer system first data that identifies the electronic datum;
processing the first data to identify a file system that is associated with the electronic datum; and
providing the computer system with second data that identifies the file system, the second data being such that it can be used by a file system mounting process to mount the file system and thereby facilitate access to the electronic datum.

9. The method as claimed in claim 8, further comprising the steps of:
receiving from the computer system third data that identifies the computer system; and
providing the computer system with fourth data, which identifies the electronic datum, subsequent to receiving the third data.

10. The method as claimed in claim 9, further comprising the steps of:
determining whether the electronic datum is updated; and
providing the computer system with fifth data, which identifies the electronic datum, subsequent to determining that the electronic datum has been updated.

11. The method as claimed in claim 10, wherein the step of receiving the first data comprises the step of receiving the first data via a communication network, and wherein the step of receiving the third data comprises the step of receiving the third data via the communication network.

12. The method as claimed in claim 10, wherein the step of providing the computer system with the second data comprises the step of sending the second data via a communication network, and wherein the step of providing the computer system with the fourth data comprises the step of sending the fourth data via the communication network, and wherein the step of providing the computer system with the fifth data comprises the step of sending the fifth data via the communication network.

13. A system for facilitating access to an electronic datum, the system comprising a processing means that is arranged to:
provide a computer system with first data that identifies the electronic datum;
receive from the computer system second data that identifies a file system that is associated with the electronic datum; and
provide the second data to a file system mounting process to effect mounting of the file system and thereby facilitate access to the electronic datum.

14. The system as claimed in claim 13, wherein the processing means is arranged to provide the second data to the file system mounting process independently of a person.

15. The system as claimed in claim 13, wherein the processing means is further arranged to:
receive from the computer system third data that identifies the electronic datum;
present the third data so as to inform a person that the electronic datum can be accessed;
determine whether the person wants to access the electronic datum; and
perform the step of providing the computer system with the first data upon determining that the person wants to access the electronic datum.

16. The system as claimed in claim 15, wherein the processing means is further arranged to:
receive from the computer system fourth data that identifies the electronic datum;
process the fourth data to determine whether a person has requested access to the electronic datum; and
perform the step of providing the second data to the file system mounting process upon determining that the person has requested access to the electronic datum.

17. The system as claimed in claim 16, wherein the processing means is further arranged to provide the computer system with fifth data that identifies a computing device on which the file mounting process can mount the file system.

18. The system as claimed in claim 17, wherein the processing means is arranged to provide the computer system with the first data and the fifth data via a communication network.

19. The system as claimed in claim 17, wherein the processing means is arranged to provide the computer system with the second data, the third data and the fourth data via a communication network.

20. A system for facilitating access to an electronic datum, the system comprising a processing means arranged to:
receive from a computer system first data that identifies the electronic datum;
process the first data to identify a file system that is associated with the electronic datum; and
provide the computer system with second data that identifies the file system, the second data being such that it can be used by a file system mounting process to mount the file system and thereby facilitate access to the electronic datum.

21. The system as claimed in claim 20, wherein the processing means is further arranged to:
receive from the computer system third data that identifies the computer system; and
provide the computer system with fourth data, which identifies the electronic datum, subsequent to receiving the third data.

22. The system as claimed in claim 21, wherein the processing means is further arranged to:
determine whether the electronic datum is updated; and
provide the computer system with fifth data, which identifies the electronic datum, subsequent to determining that the electronic datum has been updated.

23. The system as claimed in claim 22, wherein the processing means is arranged to receive the first data and the third data via a communication network.

24. The system as claimed in claim 22, wherein the processing means is arranged to provide the computer system with the second data, the fourth data, and the fifth data via a communication network.

25. A computer program comprising instructions for causing a computing device to carry out the method as claimed in claim 1.

26. A computer program comprising instructions for causing a computing device to carry out the method as claimed in claim 8.
